(19) United States
(12) Patent Application Publication
(10) Pub. No.: US 2011/0190048 A1
(43) Pub. Date: Aug. 4, 2011

(54) SYSTEM AND METHOD FOR DELIVERING AND USING FOOTBALL PLAYS

(76) Inventor: Gregory Lyle Walthour, Colorado Springs, CO (US)

(21) Appl. No.: 13/017,184

(22) Filed: Jan. 31, 2011

Related U.S. Application Data
(60) Provisional application No. 61/299,407, filed on Jan. 29, 2010.

(51) Int. Cl. A63F 13/00; A63F 9/24

(52) U.S. Cl. 463/31; 463/42

(57) ABSTRACT

A system for delivering and using football plays includes a database with a number of football plays. A server is in communication with the database. The server includes a number of operating functions. A network is in communication with the server. A client is connected to the network. A printer is in communication with the client. The printer prints a playset from the football plays. A wristband has a pocket for holding the playset. This system allows a coach to select plays and group them into a playset. The playsets are printed out and placed in a wristband. Since each play is numbered, the coach can just call out the number of the play and each player can see what their assignment is. In one embodiment, each player on the printed playset has a different color.

### RELATED APPLICATIONS

The present invention claims priority on provisional patent application, Ser. No. 61/299,407, filed on Jan. 29, 2010, entitled “Wristband Interactive” and is hereby incorporated by reference.

### STATEMENT REGARDING FEDERALLY SPONSORED RESEARCH

Not Applicable

### THE NAMES OF THE PARTIES TO A JOINT RESEARCH AGREEMENT

Not Applicable

### REFERENCE TO A SEQUENCE LISTING, A TABLE, OR A COMPUTER PROGRAM LISTING

Not Applicable

### BACKGROUND OF THE INVENTION

Football is a very popular sport that requires memorizing or drawing up plays for the team to execute. The historical ways these plays are conveyed to all players on the team include drawing the play on one's hand, drawing the play in the dirt, and creating a playbook and asking each player to memorize a call sign for each play. For any “non professional football team, specifically high school, park and recreation leagues and Pee Wee football leagues, it is difficult to get all the team members to memorize each play. This also makes it difficult to change plays if the present set of plays are not working well.

Thus there exists a need for an easier way to select, display and execute football plays.

### BRIEF SUMMARY OF INVENTION

A system for delivering and using football plays that overcomes these and other problems includes a database with a plurality of football plays. A server is in communication with the database. The server includes a plurality of operating functions. A network is in communication with the server. A client is connected to the network. A printer is in communication with the client. The printer prints a playset from the plurality of selected football plays. A wristband has a pocket for holding the playset. This system allows a coach to select plays and group them into a playset. The playsets are printed out and placed in a wristband. Since each play is numbered, the quarterback (or coach) can just call out the number of the selected play and each player can see what their assignment is. In one embodiment, each player on the printed playset has a different color.

### BRIEF DESCRIPTION OF THE SEVERAL VIEWS OF THE DRAWINGS

FIG. 1 is a block diagram of a system for delivering and using football plays in accordance with one embodiment of the embodiment;

FIG. 2 is a list of sorting functions for a system for delivering and using football plays in accordance with one embodiment of the embodiment; and

FIG. 3 is a flow chart of the steps used in a method of delivering and using football plays in accordance with one embodiment of the embodiment.

### DETAILED DESCRIPTION OF THE INVENTION

The invention is directed to a system for delivering and using football plays that includes a database with a plurality of football plays. A server is in communication with the database. The server includes a plurality of operating functions. A network is in communication with the server. A client is connected to the network. A printer is in communication with the client. The printer prints a playset from the plurality of football plays. A wristband has a pocket for holding the playset. This system allows a coach to select plays and group them into a playset. The playsets are printed out and placed in a wristband. Since each play is numbered, the coach can just call out the number of the play and each player can see what their assignment is. In one embodiment, each player on the printed playset has a different color.

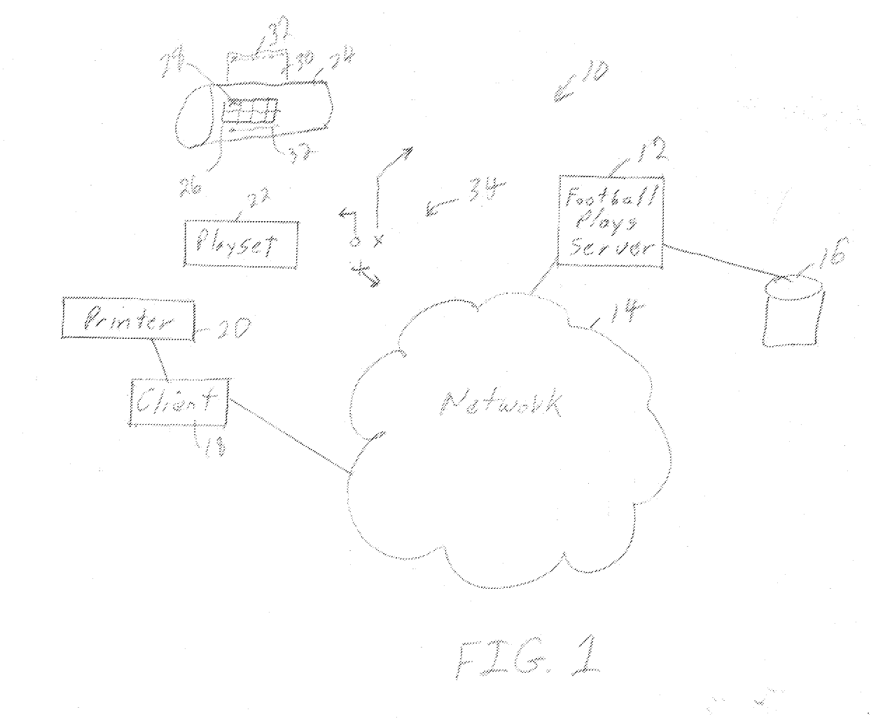

FIG. 1 is a block diagram of a system 10 for delivering and using football plays in accordance with one embodiment of the embodiment. The system 10 includes a football plays server 12 connected to a network 14. The server 12 accesses accountant information and a plurality of football plays on a database 16. A client 18, which may be a personal computer, communicates with the server 12 over the network 14. The client 18 is connected to a printer 20 which is used to print a playset 22. The playset 22 is inserted into a pocket 26 of a wristband 24 that is worn by all the players on a football team. The pocket 26 contains a clear window 28 that allows the player to see the football plays. In one embodiment, the wristband 24 has a flap 30 that covers the window 28. The flap 30 may be held closed by a hook and loop fastner 32. An example of a play 34 for a 3 man team is shown. The different symbols are commonly different colors.

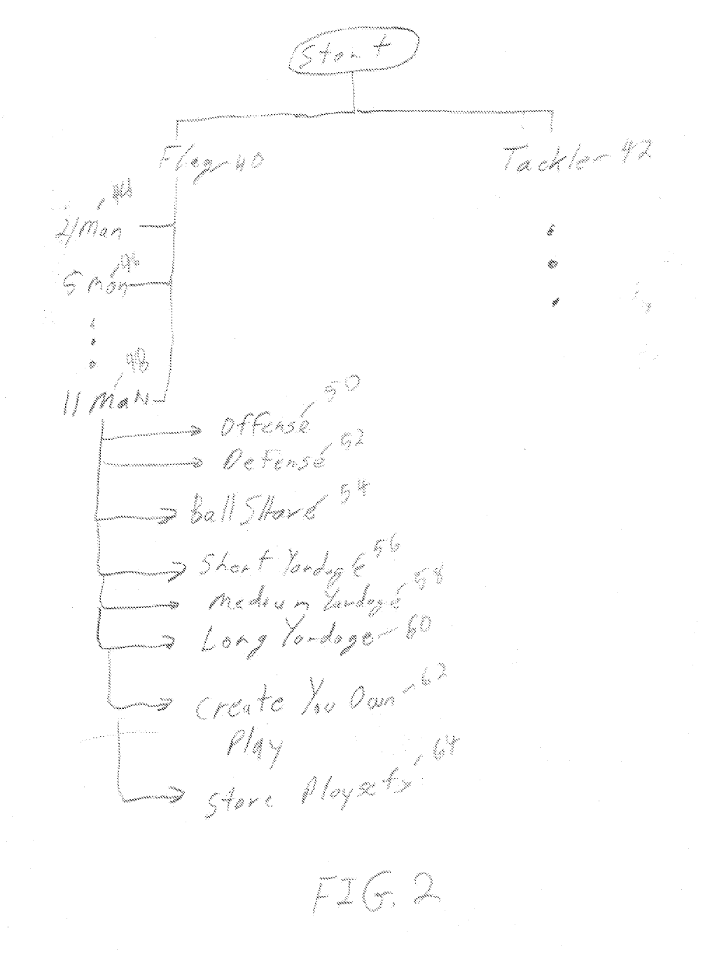

FIG. 2 is a list of sorting functions for a system for delivering and using football plays in accordance with one embodiment of the embodiment. The first sorting function is flag 40 or tackle 42 operating function. The user then may select from four man 44, five man 46, up to 11 man football 48. While these operating functions usually apply to flag football they can also apply to tackle football 42. Because of the similarities between flag and tackle football functions they will not be repeated with respect to tackle football since they will be apparent to those skilled in the art. The user can also select offense plays 50 or defensive plays 52. For offensive plays the user can select ball share 54, short yardage 56, medium yardage 58 or long yardage 60. Ball share 54 selects a group of plays where every player touches the ball. This is particularly helpful for coaches who are trying to ensure that all the players are given an equal number of plays where they receive the ball. The user can also create their own plays 62. The system has a play editor that allows the user to create their own play and store it in the database. Only that user and the people he authorizes are able to see the play. The user can also store a playset 64 once he has selected a group of plays forming a playset. Commonly a playset is eight plays that are numbered. This allows the coach to communicate everyone's assignment by just calling out a number. This is also great for hurry up offenses or in response to a hurry up offense on the defensive side.

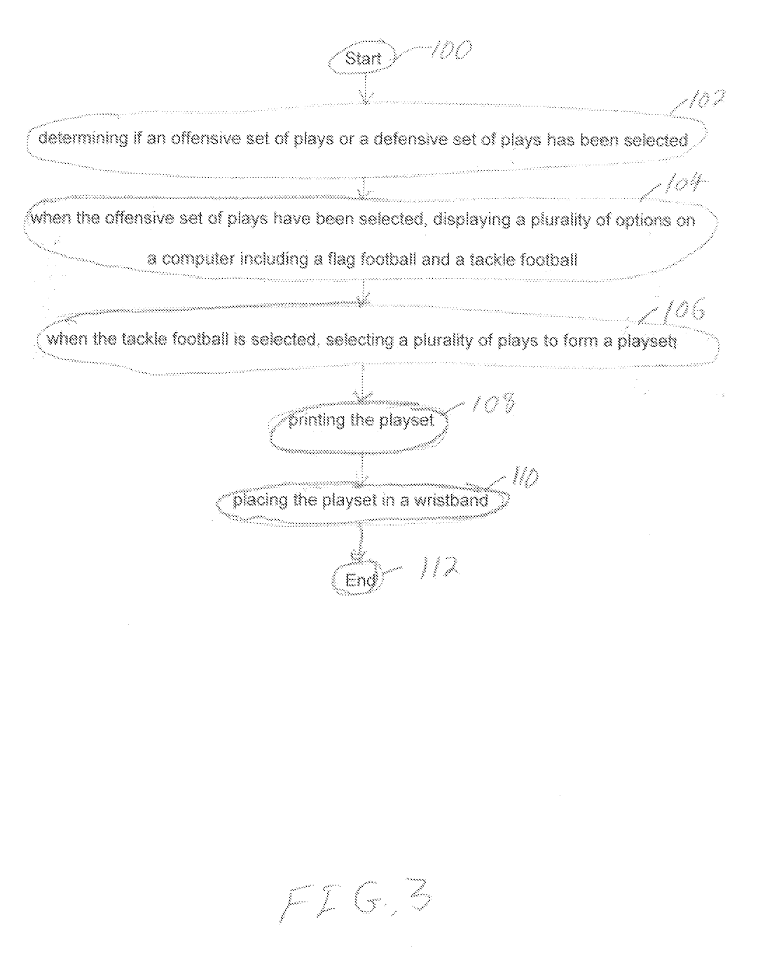

FIG. 3 is a flow chart of the steps used in a method of delivering and using football plays in accordance with one embodiment of the embodiment. The process starts, step 100, by determining if an offensive set of plays or a defensive set of plays has been selected at step 102. When the offensive set of plays have been selected at step 104, a plurality of options are displayed on a computer including a flag football and a tackle football. When tackle football is selected at step 106, the user selects a plurality of plays to form a playset at step 106. At step 108 the playset is printed. At step 110 the playset is placed in a wristband, which ends the process at step 112. In one embodiment, the playset is cut to fit a window of the selected wristband. In one embodiment, a database is populated with a plurality of football plays. In one embodiment, the user can select two point plays.

Thus there has been described a system and method that is an easier way to select, display and execute football plays.

While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

What is claimed is:

1. A system for delivering and using football plays, comprising:
a database containing a plurality of football plays;
a server in communication with the database, the server including a plurality of operating functions;
a network in communication with the server;
a client connected to the network;
a printer in communication with the client, the printer printing a playset from the plurality of football plays; and
a wristband having a pocket for holding the playset.

2. The system of claim 1, wherein one of the plurality of operating functions is a flag football function.

3. The system of claim 1, wherein one of the plurality of operating functions is a ball share function.

4. The system of claim 1, wherein one of the plurality of operating functions is a yardage function.

5. The system of claim 1, wherein one of the plurality of operating functions is a defense function.

6. The system of claim 1, wherein the wristband has a plurality of pockets.

7. The system of claim 6, wherein the plurality of pockets each have a clear window.

8. The system of claim 7, wherein the wristband includes a flap that covers one of the plurality of pockets.

9. A method of delivering and using football plays, comprising the steps of:
determining if an offensive set of plays or a defensive set of plays has been selected;
when the offensive set of plays have been selected, displaying a plurality of options on a computer including a flag football and a tackle football;
when the tackle football is selected, selecting a plurality of plays to form a playset;
printing the playset; and
placing the playset in a wristband.

10. The method of claim 9, wherein the step of determining if the offensive set of plays or the defensive set of plays has been selected, further includes the step of populating a database with a plurality of football plays.

11. The method of claim 10, further including the step of connecting a database to a server.

12. The method of claim 9, wherein the step of displaying the plurality of options on the computer includes selecting a number of players.

13. The method of claim 9, wherein the step of displaying the plurality of options on the computer includes selecting a two point conversion plays.

14. The method of claim 9, wherein the step of placing the playset in the wristband, includes cutting a piece of paper on which the playsets are printed.

15. The method of claim 9, wherein the step of placing the playset in the wristband, includes placing a defensive playset in the wristband.

16. The method of claim 9, wherein each of the plurality of plays in the playset are numbered.

17. wherein the step of displaying the plurality of options on the computer includes displaying a create play.
